(19) United States
(12) Patent Application Publication
(10) Pub. No.: US 2026/0105360 A1
(43) Pub. Date: Apr. 16, 2026

(54) SYSTEM AND METHOD FOR FEDERATED LEARNING

(71) Applicant: SEOUL NATIONAL UNIVERSITY R&DB FOUNDATION, Seoul (KR)

(72) Inventors: Bohyung HAN, Seoul (KR); Geeho KIM, Seoul (KR); Jinkyu KIM, Anyang-si (KR)

(21) Appl. No.: 18/938,708

(22) Filed: Nov. 6, 2024

(30) Foreign Application Priority Data
Oct. 14, 2024 (KR) 10-2024-0139371

(51) Int. Cl. G06N 20/00

(52) U.S. Cl. CPC G06N 20/00

(57) ABSTRACT

A federated learning method to be performed by a federated learning system may include: (a) a process of computing an estimated global gradient

$${\tilde{g}}^{t - 1}$$

by weight-averaging previous multiple global momentums at a t-th communication round by the server; (b) a process of transmitting an accelerated global model

$${θ}^{t - 1} + {\tilde{g}}^{t - 1} ,$$

which is obtained by adding the estimated global gradient

$${\tilde{g}}^{t - 1}$$

to a previous global model θ^{t-1}, to each client by the server; (c) a process of performing local learning by using the accelerated global model

$${θ}^{t - 1} + {\tilde{g}}^{t - 1}$$

as an initial point and transmitting an update of a local model to the server by each client; and (d) a process of generating a global model

$${θ}^{t} := {θ}^{t - 1} + {\tilde{g}}^{t - 1} + {Δ}^{t}$$

by aggregating a value Δ^{t} obtained by adding the update of the local model collected from each client to the accelerated global model by the server.

### CROSS-REFERENCE TO RELATED APPLICATION

This application claims the benefit under 35 USC 119 (a) of Korean Patent Applications No. 10-2024-0139371 filed on Oct. 14, 2024 in the Korean Intellectual Property Office, the entire disclosures of which are incorporated herein by reference for all purposes.

### TECHNICAL FIELD

The present disclosure relates to a system for federated learning and a federated learning method performed by the system.

### BACKGROUND

Federated learning is a large-scale machine learning framework that trains a shared model in a server through collaboration with a large number of remote clients with separate datasets. In federated learning, unlike a conventional centralized learning, data is distributed and each client updates a local model by using a gradient descent method based on local data. Then, the local models trained by the respective clients are transmitted to a server, and the server constructs a global learning model using the local models. Particularly, the global learning is computed by applying model averaging of the local models to estimate parameters of the global model.

Federated learning can be useful in environments with a high demand for protection of personal information. This is because data stored in each client is not directly used to construct the global model, but the local models trained by the respective clients are used to construct the global model, and, thus, the data or personal information stored in each client can be protected from access of the server or another client and the global model can be constructed.

However, a problem with federated learning is that there is a high likelihood of overfitting when a client performs local learning of a model on each domain. This is because when a learning agent on each client individually performs learning, a loss is computed by using a loss function to construct a learning model based solely on the data of each client, and, thus, in a process of minimizing the loss, global information of the global model is not considered or forgotten.

In the present disclosure, during such a federated learning process, it is possible to remove heterogeneity between local models by using gradient information of a global model.

### PRIOR ART DOCUMENT

Korean Patent Laid-open Publication No. 10-2024-0011703 (entitled “Bi-directional compression and privacy for efficient communication in federated learning”)

### SUMMARY

In view of the foregoing, the present disclosure is conceived to provide a federated learning system and method configured to remove heterogeneity between local models by using gradient information of a global model during a federated learning process.

The problems to be solved by the present disclosure are not limited to the above-described problems. There may be other problems to be solved by the present disclosure.

An aspect of the present disclosure provides a federated learning method to be performed by a federated learning system including a server and a plurality of clients, including: (a) a process of computing an estimated global gradient g^{˜t-1} by weight-averaging previous multiple global momentums at a t-th communication round by the server; (b) a process of transmitting an accelerated global model

$${θ}^{t - 1} + {\tilde{g}}^{t - 1} ,$$

which is obtained by adding the estimated global gradient

$${\tilde{g}}^{t - 1}$$

to a previous global model θ^{t-1}, to each client by the server; (c) a process of performing local learning by using the accelerated global model

$${θ}^{t - 1} + {\tilde{g}}^{t - 1}$$

as an initial point and transmitting an update of a local model to the server by each client; and (d) a process of generating a global model

$${θ}^{t} := {θ}^{t - 1} + {\tilde{g}}^{t - 1} + {Δ}^{t}$$

by aggregating a value Δ^{t} obtained by adding the update of the local model collected from each client to the accelerated global model by the server.

Another aspect of the present disclosure provides a federated learning method to be performed by a server with respect to a federated learning system including a server and a plurality of clients, including: (a) a process of computing an estimated global gradient

$${\tilde{g}}^{t - 1}$$

by weight-averaging previous multiple global momentums at a t-th communication round by the server; (b) a process of transmitting an accelerated global model

$${θ}^{t - 1} + {\tilde{g}}^{t - 1} ,$$

which is obtained by adding the estimated global gradient

$${\tilde{g}}^{t - 1}$$

to a previous global model θ^{t-1}, to each client by the server; (c) a process of receiving an update of a local model generated through local learning of each client by the server from each client, wherein the local learning is performed by using the accelerated global model

$${θ}^{t - 1} + {\tilde{g}}^{t - 1}$$

as an initial point; and (d) a process of generating a global model

$${θ}^{t} := {θ}^{t - 1} + {\tilde{g}}^{t - 1} + {Δ}^{t}$$

by aggregating a value Δ^{t} obtained by adding the update of the local model collected from each client to the accelerated global model by the server.

Yet another aspect of the present disclosure provides a federated learning method to be performed by a client with respect to a federated learning system including a server and a plurality of clients, including: (a) a process of receiving an accelerated global model

$${θ}^{t - 1} + {\tilde{g}}^{t - 1}$$

by the client from the server, wherein the accelerated global model is obtained by adding a previous global model θ^{t-1} to an estimated global gradient

$${\tilde{g}}^{t - 1}$$

computed by weight-averaging previous multiple global momentums at a t-th communication round; and (b) a process of performing local learning by using the accelerated global model

$${θ}^{t - 1} + {\tilde{g}}^{t - 1}$$

as an initial point and transmitting an update of a local model to the server by each client. Herein, a value Δ^{t} obtained by aggregating the update of the local model transmitted from each client is added to the accelerated global model

$${θ}^{t - 1} + {\tilde{g}}^{t - 1}$$

and then output as a global model

$${θ}^{t} := {θ}^{t - 1} + {\tilde{g}}^{t - 1} + {Δ}^{t} .$$

Still another aspect of the present disclosure provides a server constituting a federated learning system, including: a communication module; a memory that stores a server-side federated learning program; and a processor that executes the federated learning program. Herein, the federated learning program includes a code configured to perform the federated learning method according to the present disclosure.

Still another aspect of the present disclosure provides a client constituting a federated learning system, including: a communication module; a memory that stores a client-side federated learning program; and a processor that executes the federated learning program. Herein, the federated learning program includes a code configured to perform the federated learning method according to the present disclosure.

Still another aspect of the present disclosure provides a federated learning system, including: a server; and a plurality of clients connected to the server via communication. Herein, the server executes a federated learning program including a code configured to perform the federated learning method according to the present disclosure and the client includes a code configured to perform the federated learning method according to the present disclosure.

According to an embodiment of the present disclosure, it is possible to estimate a robust global gradient with respect to hyperparameters due to multiple global momentums and aggregation of probabilistic information thereof.

Also, a server and a client communicate only model parameters without imposing additional network overhead for transmitting gradients or other information. This is a significant advantage for many practical federated learning applications involving clients with limited network bandwidths.

Further, the system and method of according to the present disclosure are robust to a low participation rate of clients and allow new-arriving clients to immediately join a training process because clients are supposed to neither store their local states nor use them for model updates.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different FIGS. indicates similar or identical items.

FIG. 1 is a configuration view of a federated learning system according to an embodiment of the present disclosure.

FIG. 2 is a configuration view of a server included in the federated learning system.

FIG. 3 is a configuration view of a client included in the federated learning system.

FIG. 4 is a conceptual illustration of the features of the present disclosure.

FIG. 5 is a flowchart showing a federated learning method according to an embodiment of the present disclosure.

FIG. 6 is a flowchart showing a server-side federated learning method according to an embodiment of the present disclosure.

FIG. 7 is a flowchart showing a client-side federated learning method according to an embodiment of the present disclosure.

FIG. 8 shows a pseudo-code of the federated learning method according to an embodiment of the present disclosure.

### DETAILED DESCRIPTION

Hereafter, embodiments will be described in detail with reference to the accompanying drawings so that the present disclosure may be readily implemented by a person with ordinary skill in the art. However, it is to be noted that the present disclosure is not limited to the embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected to” another element and an element being “electronically connected to” another element via another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Throughout the whole document, the term “unit” includes a unit implemented by hardware, a unit implemented by software, and a unit implemented by both of them. One unit may be implemented by two or more pieces of hardware, and two or more units may be implemented by one piece of hardware. Meanwhile, the units are not limited to the software or the hardware, and each of the units may be stored in an addressable storage medium or may be configured to implement one or more processors. Accordingly, the units may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and the functions of the units can be combined with each other or can be divided up into additional components and units. Further, the components and the “units” may be configured to implement one or more CPUs in a device or a secure multimedia card.

Hereafter, exemplary embodiments of the present disclosure will be described in detail with reference to the accompanying drawings.

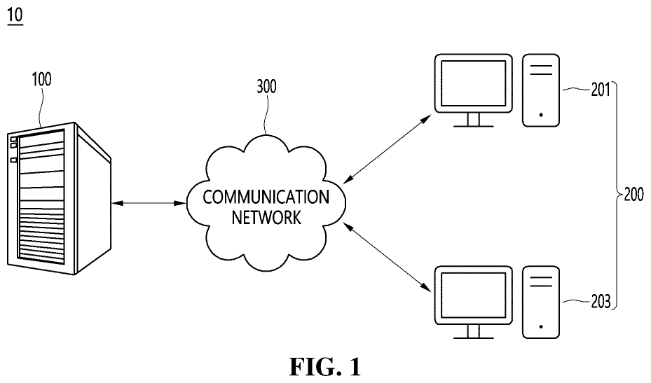

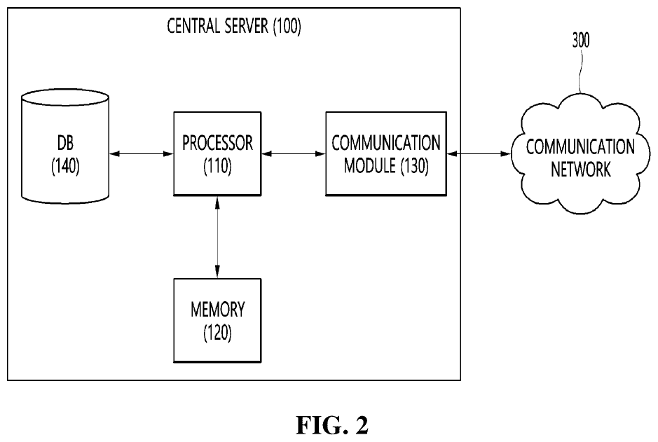

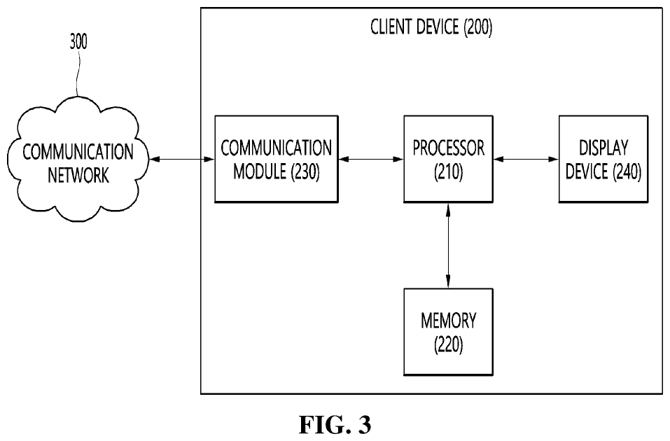

FIG. 1 is a configuration view of a federated learning system according to an embodiment of the present disclosure, FIG. 2 is a configuration view of a server included in the federated learning system, and FIG. 3 is a configuration view of a client included in the federated learning system.

As shown in the drawings, a federated learning system 10 includes a server 100, a plurality of clients 200, 201 and 203, and a communication network 300. In the federated learning system 10, the server 100 trains a global model and each client 200 trains a local model. The global model is constructed via federated learning and the constructed global model is propagated to each client 200 and used as an initial point for local learning.

Referring to FIG. 2, the server 100 includes a processor 110, a memory 120, a communication module 130, and a database 140. The server 100 executes a federated learning program to compute an estimated global gradient by weight-averaging previous multiple global momentums and computes an accelerated global model by adding the estimated global gradient to a previous global model. Further, the server 100 transmits the accelerated global model to the client 200 to train the local model. Furthermore, the server 100 collects and aggregates an update of the local model of each client 200 and adds the update to the accelerated global model to generate a final global model. The server 100 may operate in a cloud computing service model, such as software as a service (SaaS), platform as a service (PaaS), or infrastructure as a service (IaaS). Also, the server 100 may be constructed in the form of a private cloud, a public cloud or a hybrid cloud.

The processor 110 executes a federated learning program stored in the memory 120, and provides a function to control hardware of the server 100 upon execution of the program. That is, the processor 110 may perform a hardware control function, such as a file system, memory allocation, a network, a basic library, a timer, device control (display, media, input device, 3D, or the like), and other utilities required upon execution of the program.

The processor 110 may refer to, for example, a data processing device embedded in hardware having a physically structured circuit to perform a function expressed as a code or an instruction included in the program. An example of the data processing device embedded in the hardware as described above includes a processing device, such as a microprocessor, a central processing unit (CPU), a processor core, a multiprocessor, an application-specific integrated circuit (ASIC), or a field programmable gate array (FPGA), but the present disclosure is not limited thereto. The processor 100 may further include a graphics processing unit (GPU), a tensor processing unit (TPU), etc. as a deep learning accelerator.

For reference, each of components illustrated in FIG. 2 in accordance with the embodiment of the present disclosure may imply software or hardware such as a field programmable gate array (FPGA) or an application specific integrated circuit (ASIC), and they carry out predetermined functions.

However, the components are not limited to the software or the hardware, and each of the components may be stored in an addressable storage medium or may be configured to implement one or more processors.

Accordingly, the components may include, for example, software, object-oriented software, classes, tasks, processes, functions, attributes, procedures, sub-routines, segments of program codes, drivers, firmware, micro codes, circuits, data, database, data structures, tables, arrays, variables and the like.

The components and functions thereof can be combined with each other or can be divided up into additional components.

The memory 120 stores a server-side program configured to perform the federated learning method. Also, the memory 120 performs a function of temporarily or permanently storing data processed by the processor 110. Herein, the memory 120 may include volatile storage media or non-volatile storage media, but the present disclosure is not limited thereto.

The communication module 130 performs communication with the clients 200, 201 and 203 constituting the federated learning system 10 under the control of the processor 110.

The database 140 stores various data generated while the processor 110 performs a series of operations. For example, information about various clients included in the federated learning system 10 and training data for training the global model may be stored in the database 140.

Further, referring to FIG. 3, the client 200 may include a processor 210, a memory 220, a communication module 230, and a display 240. The client 200 may be implemented with computers or portable devices which can access the server 100 through a network. Herein, the computers may include, for example, a notebook, a desktop, and a laptop equipped with a WEB browser. The portable devices are, for example, wireless communication devices that ensure portability and mobility and may include all kinds of handheld-based wireless communication devices, such as a smart phone, a tablet PC, a smart watch, and the like.

The client 200 trains the local model based on the accelerated global model received from the server 100 and transmits an update of the local model to the server 100. Then, the client 200 receives the final global model from the server 100 to further train the local model, or inputs data collected by the client 200 into the local model to perform an inference operation.

The processor 210 executes a federated learning program stored in the memory 220, and provides a function to control hardware of the client 200 upon execution of the program. That is, the processor 210 may perform a hardware control function, such as a file system, memory allocation, a network, a basic library, a timer, device control (display, media, input device, 3D, or the like), and other utilities required upon execution of the program. A detailed configuration of the processor 210 may be the same as that of the processor 110 in the server 100.

The memory 220 stores a client-side program configured to perform the federated learning method. Also, the memory 220 performs a function of temporarily or permanently storing data processed by the processor 210. Herein, the memory 220 may include volatile storage media or non-volatile storage media, but the present disclosure is not limited thereto.

The communication module 230 performs communication with the server 100 constituting the federated learning system 10 under the control of the processor 210.

The display 240 serves as an interface device between each client 200 and a user, and may display various information or receive input from the user.

Hereafter, processes of the federated learning method according to the present disclosure will be described in detail. According to the federated learning method of the present disclosure, an initial point for each client learning model is modified by aggregating a plurality of estimated global gradients and the global model.

First, a conventionally known method (FedAvg, Brendan McMahan, Eider Moore, Daniel Ramage, Seth Hampson, and Blaise Aguera y Arcas. Communicationefficient learning of deep networks from decentralized data. In AISTATS, 2017) will be described with reference to the following Equations 1 to 4.

Equation 1 is an empirical loss function of a client Cᵢ.

$${ℒ}_{i} ( θ ) := {E}_{( x , y ) ∼ {D}_{i}} [ {ℓ}_{i} ( ( x , y ) ; θ ) ] \qquad [ Equation 1 ]$$

[symbol] ᵢ denotes a local data set of each client. Federated learning has a goal to construct a global model that minimizes the average loss of all clients, and it can be expressed by the following Equation 2.

$${min}_{θ} \{ ℒ ( θ ) := {\sum }_{i = 1}^{N} {ω}_{i} {ℒ}_{i} ( θ ) \} \qquad [ Equation 2 ]$$

Herein, θ is a parameter of the global model, N is the number of clients, and [symbol] ᵢ is a normalized weight of each client, which is proportional to the size of each local dataset [symbol] ᵢ.

The datasets of the respective clients are independent and identically distributed (Non-IID). The datasets are different from each other in nature and have heterogeneous distributions.

The server collects a local model from each client to generate a global model for federated learning. To this end, the server broadcasts the latest global model θ^{t-1} to each client at a t-th communication round. Therefore, each client sets the latest global model θ^{t-1} as an initial point

$${θ}_{i , 0}^{t} := {θ}^{t - 1}$$

and optimizes each local model. After K number of iterations of local learning, each client transmits its local updates

$${Δ}_{i}^{t} := {θ}_{i , K}^{t} - {θ}_{i , 0}^{t}$$

to the server. For reference, the local update refers to the difference between a learning model trained through K number of iterations of local learning and an initial point received by each client.

The server collects and aggregates the local updates

$${Δ}_{i}^{t} := {θ}_{i , K}^{t} - {θ}_{i , 0}^{t}$$

transmitted from each client, and obtains an average local update Δ^{t} that represents an average update of the local models as defined by Equation 3. Herein, the average local update Δ^{t} is used as an update of the global model.

$${Δ}^{t} := {\sum }_{i ∈ {S}_{t}} {w}_{i} {Δ}_{i}^{t} \qquad [ Equation 3 ]$$

Herein, Sₜ⊆{C₁, . . . , C_{N}} is satisfied.

Then, a new global model θ^{t} can be defined as shown in Equation 4 by using the average local update.

$${θ}^{t} := {θ}^{t - 1} + {Δ}^{t} \qquad [ Equation 4 ]$$

However, in the conventional technology, overfitting may occur in each client. To address this issue, the present disclosure proposes a new method by which an initial point for each client learning model is modified by aggregating a plurality of estimated global gradients and the global model.

To clearly compare the operations performed by the server 100 and the client 200 according to the present disclosure with those according to the conventional technology, the symbols and definitions used in Equations 1 to 4 described above will also be used in the following description.

The server 100 computes a local gradient by using the latest global momentum m^{t-1} at a t-th communication round.

First, the global momentum can be computed according to Equation 5 at each communication round.

$${m}^{t - 1} := λ {m}^{t - 2} + {Δ}^{t - 1} \qquad [ Equation 5 ]$$

That is, the latest global momentum m^{t-1} can be computed based on the sum of the average local update Δ^{t-1} and a previous global momentum λm^{t-2} at the latest communication round t-1. Herein, λ is a coefficient that controls the influence of the average local update amount of previous local models, and as the value of λ increases, the influence of the average local update amount of previous local models increases. Therefore, according to the present disclosure, λ may have different values to estimate the global gradient from a plurality of perspectives. That is, multiple global momentums

$${m}_{1}^{t - 1} , … , {m}_{L}^{t - 1}$$

defined by L number of a plurality of momentum coefficients λ₁, . . . , λ_{L} is used. That is, a global momentum at a first point in time can be defined as the sum of values obtained by multiplying L number of momentum coefficients by L number of global momentums, respectively, at a second point in time, which is a previous point in time, and an average local update at the first point in time.

Further, to obtain a global gradient estimate by aggregating a plurality of global momentum estimates, a probabilistic-weighted average can be used. That is, weightings

$${w}_{1}^{t - 1} , … , {w}_{L}^{t - 1}$$

respectively corresponding to multiple global momentums are defined, and the sum of the weightings is fixed to 1, but values of the respective weightings can be randomly changed at each communication round. An estimated global gradient computed as described above can be defined as shown in Equation 6.

$${\tilde{g}}^{t - 1} = {\sum }_{l = 1}^{L} {w}_{l}^{t - 1} {λ}_{l} {m}_{l}^{t - 1} \qquad [ Equation 6 ]$$

That is, the estimated global gradient

$${\tilde{g}}^{t - 1}$$

at a current communication round t can be defined as a weighted average of a plurality of latest global momentums

$${λ}_{l} {m}_{l}^{t - 1} .$$

Therefore, it is possible to effectively aggregate several individual global gradient estimates.

Further, the estimated global gradient shown in Equation 6 is transmitted each client at the current communication round t and used to modify an initial point for each local model.

That is, unlike the conventional technology by which transmission to each client is performed based on the latest global model θ^{t-1} as an initial point, the server 100 transmits the sum of the estimated global gradient

$${\tilde{g}}^{t - 1}$$

defined by Equation 7 and the latest global model θ^{t-1} to each client 200 and each client performs local learning by using it as an initial point. Herein, the sum of the estimated global gradient

$${\tilde{g}}^{t - 1}$$

and the latest global model can be θ^{t-1} can be defined as the accelerated global model

$${θ}^{t - 1} + {\tilde{g}}^{t - 1} .$$

In this case, the server 100 can transmit defined as the accelerated global model the accelerated global model to a sampled client 200 among all the clients.

$${θ}^{t - 1} + {\tilde{g}}^{t - 1} \qquad [ Equation 7 ]$$

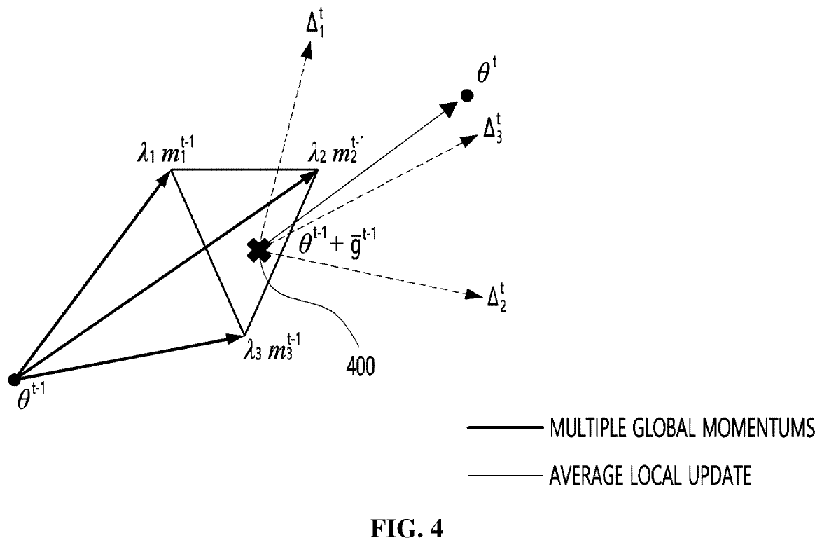

FIG. 4 is a conceptual illustration of the features of the present disclosure. For example, the sum of multiple global momentums indicated by three arrows and the latest global model θ^{t-1} can be used as an initial point 400 for constructing a local model of each client.

Then, each client 200 transmits, to the server 100, each update of a local model as a result of local learning based on the initial point 400, and the server 100 collects and collects and aggregates an update

$${Δ}_{i}^{t} := {θ}_{i , K}^{t} - {θ}_{i , 0}^{t}$$

of the local model and obtains a global update Δ^{t} as described above in Equation 3.

Then, a final global model can be output by adding the accelerated global model

$${θ}^{t - 1} + {\tilde{g}}^{t - 1}$$

to the global update Δ^{t} as shown in Equation 8.

$${θ}^{t} := {θ}^{t - 1} + {\tilde{g}}^{t - 1} + {Δ}^{t} \qquad [ Equation 8 ]$$

As described above, the estimated global gradient based on the multiple global momentums is used to determine a unified initial point for constructing a local model of each client, and, thus, each client finds its local optimal solution from the initial point. This approach guides learning in individual client domains toward optimal points near a global learning trajectory and suppresses information loss of a global model caused by local learning.

Further, in order to ensure that local learning performed in each client does not deviate from a direction of global learning, a regularization loss (regularization with momentum-integrated model) can be considered. To this end, a loss function of each client 200 is set as shown in Equation 9 to regularize a difference between the local model

$${θ}_{i , k}^{t}$$

and the accelerated global model

$${θ}^{t - 1} + {\tilde{g}}^{t - 1} . \qquad [ Equation 9 ]$$

$$\frac{β}{2} {\vert {θ}_{i , k}^{t} - ( {θ}^{t - 1} + {\tilde{g}}^{t - 1} ) \vert}^{2}$$

Herein, β is a coefficient that controls the intensity of regularization.

As described above, the modified loss function uses the estimated global gradient

$${\tilde{g}}^{t - 1}$$

to reduce a change in local update

$${Δ}_{i}^{t} := {θ}_{i , K}^{t} - {θ}_{i , 0}$$

in order to suppress deviation of the local model from the initial point determined by the accelerated global model

$${θ}^{t - 1} + {\tilde{g}}^{t - 1} .$$

According to the method of the present disclosure, any additional communication costs are not required to convey learning information. Therefore, it can be more efficiently used in a mobile environment with limited network bandwidths or an Internet of Things (IoT) environment.

As described above, after K number of iterations of local learning, each client 200 returns local updates

$${Δ}_{i}^{t}$$

to the server 100, and the server 100 collects and aggregates the local updates of each client 200 to obtain a global update Δ^{t} and updates multiple global momentums based on the global update Δ^{t}. Thus, the server 100 obtains a global momentum

$${m}_{l}^{t} = {λ}_{l} {m}_{l}^{t - 1} + {Δ}^{t}$$

at a current round as described above with reference to Equation 5, and obtains a final global model as shown in Equation 8.

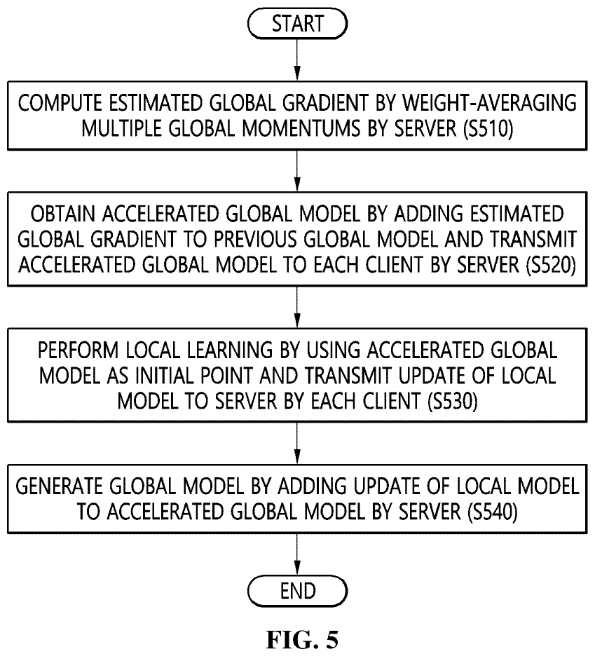

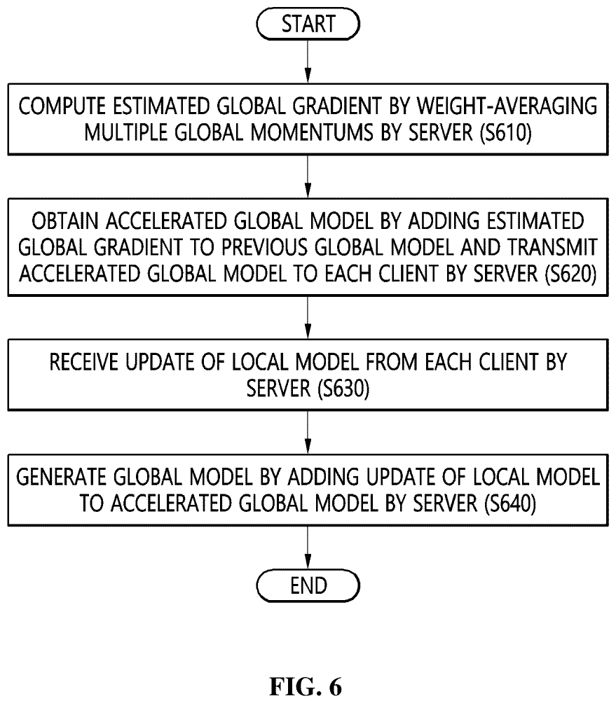

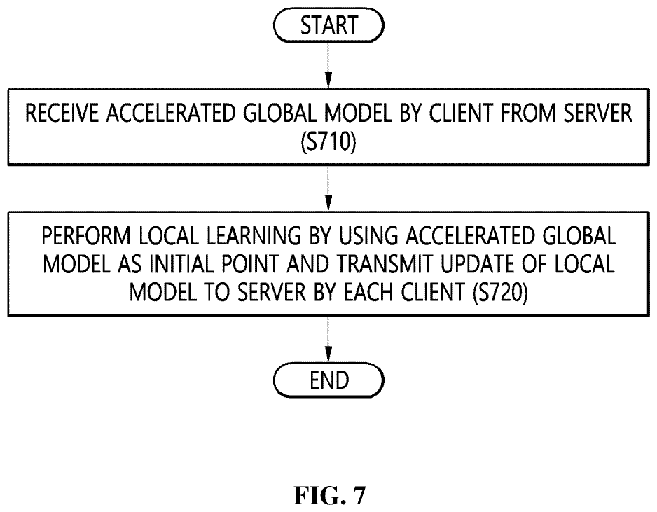

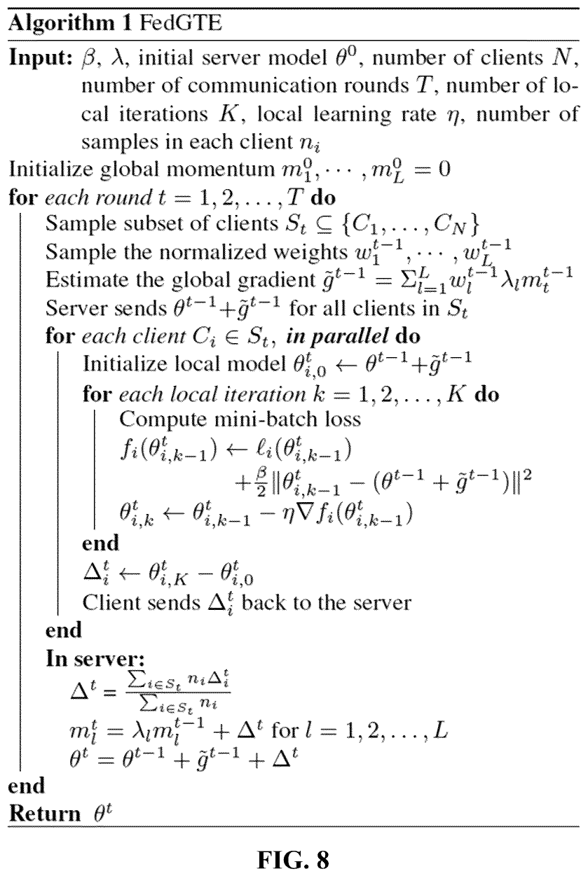

FIG. 5 is a flowchart showing a federated learning method according to an embodiment of the present disclosure, FIG. 6 is a flowchart showing a server-side federated learning method according to an embodiment of the present disclosure, FIG. 7 is a flowchart showing a client-side federated learning method according to an embodiment of the present disclosure, and FIG. 8 shows a pseudo-code of the federated learning method according to an embodiment of the present disclosure.

First, referring to FIG. 5, the server 100 computes an estimated global gradient

$${\tilde{g}}^{t - 1}$$

by weight-averaging previous multiple global momentums at a t-th communication round (S510). The details thereof are the same as described above with reference to Equation 5 and Equation 6.

That is, the estimated global gradient is computed by using the multiple global momentums as shown in

$${\tilde{g}}^{t - 1} = {{\sum }^{L}}_{l = 1} {w}_{l}^{t - 1} {λ}_{l} {m}_{l}^{t - 1} ,$$

and herein, λ is a coefficient that controls the influence of the average local update amount of previous local models and is obtained by applying weightings

$${w}_{1}^{t - 1} , … , {w}_{L}^{t - 1}$$

to multiple global momentums

$${m}_{1}^{t - 1} , … , {m}_{L}^{t - 1}$$

defined by L number of a plurality of momentum coefficients λ₁, . . . , λ_{L} and aggregating them.

Then, the server 100 obtains an accelerated global model

$${θ}^{t - 1} + {\tilde{g}}^{t - 1}$$

by adding the estimated global gradient

$${\tilde{g}}^{t - 1}$$

to a previous global model θ^{t-1} and transmits the accelerated global model

$${θ}^{t - 1} + {\tilde{g}}^{t - 1}$$

to each client (S520). The details thereof are the same as described above with reference to Equation 7.

Thereafter, each client 200 performs local learning by using the accelerated global model

$${θ}^{t - 1} + {\tilde{g}}^{t - 1}$$

as an initial point and transmits an update of a local model to the server (S530). In this case, each client 200 uses a loss function represented by Equation 9 to perform regularization.

Then, the server 100 generates a global model

$${θ}^{t} := {θ}^{t - 1} + {\tilde{g}}^{t - 1} + {Δ}^{t}$$

by aggregating a value Δ^{t} obtained by adding the update of the local model collected from each client 200 to the accelerated global model (S540). The details thereof are the same as described above with reference to Equation 8.

The local model and the global model are continuously trained through iteration of the above-described processes S510 to S540, and each of the client and the server can perform an inference operation by using each local model and the global model.

Then, referring to FIG. 6, the server 100 computes an estimated global gradient

$${\tilde{g}}^{t - 1}$$

by weight-averaging previous multiple global momentums at a t-th communication round (S610). The details thereof are the same as described above with reference to Equation 5 and Equation 6.

Then, the server 100 obtains an accelerated global model

$${θ}^{t - 1} + {\tilde{g}}^{t - 1}$$

by adding the estimated global gradient

$${\tilde{g}}^{t - 1}$$

to a previous global model θ^{t-1} and transmits the accelerated global model

$${θ}^{t - 1} + {\tilde{g}}^{t - 1}$$

to each client (S620). The details thereof are the same as described above with reference to Equation 7.

Thereafter, the server 100 receives an update of a local model from each client 200 (S630). In this case, each client 200 uses a loss function represented by Equation 9 to perform regularization.

Then, the server 100 generates a global model

$${θ}^{t} := {θ}^{t - 1} + {\tilde{g}}^{t - 1} + {Δ}^{t}$$

by aggregating a value Δ^{t} obtained by adding the update of the local model collected from each client 200 to the accelerated global model (S640). The details thereof are the same as described above with reference to Equation 8.

The local model and the global model are continuously trained through iteration of the above-described processes S610 to S640, and the server 100 can perform an inference operation by using the global model constructed as described above.

Then, referring to FIG. 7, the client 200 receives an accelerated global model

$${θ}^{t - 1} + {\tilde{g}}^{t - 1}$$

from the server 100 (S710). The accelerated global model is the same as described above with reference to Equation 5 to Equation 7.

Thereafter, each client 200 performs local learning by using the accelerated global model

$${θ}^{t - 1} + {\tilde{g}}^{t - 1}$$

as an initial point and transmits an update of a local model to the server (S720). In this case, each client 200 uses a loss function represented by Equation 9 to perform regularization.

The transmitted update of the local model is used to generate a global model

$${θ}^{t} := {θ}^{t - 1} + {\tilde{g}}^{t - 1} + {Δ}^{t} .$$

The details thereof are the same as described above with reference to Equation 8.

The local model and the global model are continuously trained through iteration of the above-described processes S510 to S540, and the client 200 can perform an inference operation by using the local model constructed as described above.

Referring to FIG. 8, β (a coefficient that controls the intensity of regularization shown in Equation 9), a plurality of momentum coefficients, a plurality of momentum coefficients λ₁, . . . , λ_{L}, an initial global model θ⁰, the number of clients N, the number of communication rounds T, the number of iterations of training the local model K, a local learning rate η, the number of samples in each client nᵢ may be input.

Then, multiple global momentums

$${m}_{1}^{0} , … , {m}_{L}^{0}$$

is initialized to 0.

The following operations may be performed at each of T number of communication rounds.

Client sampling: Sampling of a subset of clients participating in each communication round is performed from all subsets of clients.

Global gradient estimation: An estimated global gradient is computed by aggregating information of multiple global momentums

$${m}_{1}^{t - 1} , … , {m}_{L}^{t - 1}$$

as described above with reference to Equation 5 and Equation 6.

Model transmission from server to client: The server transmits an accelerated global model to all of the sampled clients.

Operation of client: Each client sets the accelerated global model as an initial point and performs local learning. In this case, each client may perform the following operations to each data in a minibatch. A cross-entropy loss is obtained, and a minibatch loss is computed by using a regularization loss with respect to a difference between a current value and an initial value of a parameter of a local model. The local model parameter is updated by applying the computed loss and the gradient descent method. Then, the client computes a difference between the updated local model parameter and an initial local model and transmits the difference to the server as a local update.

Model construction by server: An average of local updates received from the client is computed and then used to construct a global model as shown in Equation 8.

The embodiment of the present disclosure can be embodied in a non-transitory storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The method and system of the present disclosure have been explained in relation to a specific embodiment, but their components or a part or all of their operations can be embodied by using a computer system having general-purpose hardware architecture.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

### EXPLANATION OF CODES

10: Federated learning system
100: Server
200: Client
300: Communication network

What is claimed is:

1. A federated learning method to be performed by a federated learning system including a server and a plurality of clients, comprising:
(a) a process of computing an estimated global gradient
$${\tilde{g}}^{t - 1}$$
by weight-averaging previous multiple global momentums at a t-th communication round by the server;
(b) a process of transmitting an accelerated global model
$${θ}^{t - 1} + {\tilde{g}}^{t - 1} ,$$
which is obtained by adding the estimated global gradient
$${\tilde{g}}^{t - 1}$$
to a previous global model θ^{t-1}, to each client by the server;
(c) a process of performing local learning by using the accelerated global model
$${θ}^{t - 1} + {\tilde{g}}^{t - 1}$$
as an initial point and transmitting an update of a local model to the server by each client; and
(d) a process of generating a global model
$${θ}^{t} := {θ}^{t - 1} + {\tilde{g}}^{t - 1} + {Δ}^{t}$$
by aggregating a value Δ^{t} obtained by adding the update of the local model collected from each client to the accelerated global model by the server.

2. The federated learning method of claim 1,
wherein in the process (a), the estimated global gradient is computed according to the following Equation,
λ is a coefficient that controls the influence of the average local update amount of previous local models and is obtained by applying weightings
$${w}_{1}^{t - 1} , … , {w}_{L}^{t - 1}$$
to multiple global momentums
$${m}_{1}^{t - 1} , … , {m}_{L}^{t - 1}$$
defined by L number of a plurality of momentum coefficients λ₁, . . . , λ_{L} and aggregating them:
$${\tilde{g}}^{t - 1} = {\sum }_{l = 1}^{L} {w}_{l}^{t - 1} {λ}_{l} {m}_{l}^{t - 1} . \qquad [ Equation ]$$

3. The federated learning method of claim 1,
wherein the update of the local model in the process (c) is computed by regularizing a difference between a local model
$${θ}_{i , k}^{t}$$
and the accelerated global model
$${θ}^{t - 1} + {\tilde{g}}^{t - 1}$$
according to a loss function defined by the following Equation, and β is a coefficient that controls the intensity of regularization:
$$\frac{β}{2} {\vert {θ}_{i , k}^{t} - ( {θ}^{t - 1} + {\tilde{g}}^{t - 1} ) \vert}^{2} . \qquad [ Equation ]$$

4. A federated learning method to be performed by a server with respect to a federated learning system including a server and a plurality of clients, comprising:
(a) a process of computing an estimated global gradient
$${\tilde{g}}^{t - 1}$$
by weight-averaging previous multiple global momentums at a t-th communication round by the server;
(b) a process of transmitting an accelerated global model
$${θ}^{t - 1} + {\tilde{g}}^{t - 1} ,$$
which is obtained by adding the estimated global gradient
$${\tilde{g}}^{t - 1}$$
to a previous global model θ^{t-1}, to each client by the server;
(c) a process of receiving an update of a local model generated through local learning of each client by the server from each client, wherein the local learning is performed by using the accelerated global model
$${θ}^{t - 1} + {\tilde{g}}^{t - 1}$$
as an initial point; and
(d) a process of generating a global model
$${θ}^{t} := {θ}^{t - 1} + {\tilde{g}}^{t - 1} + {Δ}^{t}$$
by aggregating a value Δ^{t} obtained by adding the update of the local model collected from each client to the accelerated global model by the server.

5. The federated learning method of claim 4,
wherein in the process (a), the estimated global gradient is computed according to the following Equation,
λ is a coefficient that controls the influence of the average local update amount of previous local models and is obtained by applying weightings
$${w}_{1}^{t - 1} , … , {w}_{L}^{t - 1}$$
to multiple global momentums
$${m}_{1}^{t - 1} , … , {m}_{L}^{t - 1}$$
defined by L number of a plurality of momentum coefficients λ₁, . . . , λ_{L} and aggregating them:
$${\tilde{g}}^{t - 1} = {\sum }_{l = 1}^{L} {w}_{l}^{t - 1} {λ}_{l} {m}_{l}^{t - 1} . \qquad [ Equation ]$$

6. The federated learning method of claim 4,
wherein the update of the local model in the process (c) is computed by regularizing a difference between a local model
$${θ}_{i , k}^{t}$$
and the accelerated global model
$${θ}^{t - 1} + {\tilde{g}}^{t - 1}$$
according to a loss function defined by the following Equation, and β is a coefficient that controls the intensity of regularization:
$$\frac{β}{2} {\vert {θ}_{i , k}^{t} - ( {θ}^{t - 1} + {\tilde{g}}^{t - 1} ) \vert}^{2} . \qquad [ Equation ]$$

7. A federated learning method to be performed by a client with respect to a federated learning system including a server and a plurality of clients, comprising:
(a) a process of receiving an accelerated global model
$${θ}^{t - 1} + {\tilde{g}}^{t - 1}$$
by the client from the server, wherein the accelerated global model is obtained by adding a previous global model θ^{t-1} to an estimated global gradient
$${\tilde{g}}^{t - 1}$$
computed by weight-averaging previous multiple global momentums at a t-th communication round; and
(b) a process of performing local learning by using the accelerated global model
$${θ}^{t - 1} + {\tilde{g}}^{t - 1}$$
as an initial point and transmitting an update of a local model to the server by each client,
wherein a value Δ^{t} obtained by aggregating the update of the local model transmitted from each client is added to the accelerated global model
$${θ}^{t - 1} + {\tilde{g}}^{t - 1}$$
and then output as a global model
$${θ}^{t} := {θ}^{t - 1} + {\tilde{g}}^{t - 1} + {Δ}^{t} .$$

8. The federated learning method of claim 7,
wherein the estimated global gradient is computed according to the following Equation,
λ is a coefficient that controls the influence of the average local update amount of previous local models and is obtained by applying weightings
$${w}_{1}^{t - 1} , … , {w}_{L}^{t - 1}$$
to multiple global momentums
$${m}_{1}^{t - 1} , … , {m}_{L}^{t - 1}$$
defined by L number of a plurality of momentum coefficients λ₁, . . . , λ_{L} and aggregating them:
$${\tilde{g}}^{t - 1} = {\sum }_{l = 1}^{L} {w}_{l}^{t - 1} {λ}_{l} {m}_{l}^{t - 1} . \qquad [ Equation ]$$

9. The federated learning method of claim 7,
wherein in the process (b), the local learning is performed by regularizing a difference between a local model
$${θ}_{i , k}^{t}$$
and the accelerated global model
$${θ}^{t - 1} + {\tilde{g}}^{t - 1}$$
according to a loss function defined by the following Equation to compute the update of the local model, and
β is a coefficient that controls the intensity of regularization:
$$\frac{β}{2} {\vert {θ}_{i , k}^{t} - ( {θ}^{t - 1} + {\tilde{g}}^{t - 1} ) \vert}^{2} . \qquad [ Equation ]$$

10. A server constituting a federated learning system, comprising:
a communication module;
a memory that stores a server-side federated learning program; and
a processor that executes the federated learning program,
wherein the federated learning program includes a code configured to perform the federated learning method of claim 4.

11. A client constituting a federated learning system, comprising:
a communication module;
a memory that stores a client-side federated learning program; and
a processor that executes the federated learning program,
wherein the federated learning program includes a code configured to perform the federated learning method of claim 7.

12. A federated learning system, comprising:
a server; and
a plurality of clients connected to the server via communication,
wherein the server executes a federated learning program including a code configured to perform the federated learning method of claim 4, and
wherein the client executes a federated learning program including a code configured to perform a federated learning method comprising:
(a) a process of receiving an accelerated global model
$${θ}^{t - 1} + {\tilde{g}}^{t - 1}$$
by the client from the server, wherein the accelerated global model is obtained by adding a previous global model θ^{t-1} to an estimated global gradient
$${\tilde{g}}^{t - 1}$$
computed by weight-averaging previous multiple global momentums at a t-th communication round; and
(b) a process of performing local learning by using the accelerated global model
$${θ}^{t - 1} + {\tilde{g}}^{t - 1}$$
as an initial point and transmitting an update of a local model to the server by each client,
wherein a value Δ^{t} obtained by aggregating the update of the local model transmitted from each client is added to the accelerated global model
$${θ}^{t - 1} + {\tilde{g}}^{t - 1}$$
and then output as a global model
$${θ}^{t} := {θ}^{t - 1} + {\tilde{g}}^{t - 1} - {Δ}^{t} .$$

13. A computer-readable non-transitory storage medium that stores a computer program configured to perform the federated learning method of claim 1.
